(19) United States
(12) Patent Application Publication
(10) Pub. No.: US 2025/0220032 A1
(43) Pub. Date: Jul. 3, 2025

(54) NETWORK TRAFFIC BEHAVIORAL HISTOGRAM ANALYSIS AND ATTACK DETECTION

(71) Applicant: A10 NETWORKS, INC., San Jose, CA (US)

(72) Inventors: Yutun (Tony) Tseng, San Jose, CA (US); Chia-Shing Hunag, San Jose, CA (US); Yu Chieh Lin, San Jose, CA (US); Wet-Ti Su, San Jose, CA (US)

(21) Appl. No.: 18/401,690

(22) Filed: Jan. 1, 2024

(51) Int. Cl. H04L 9/40

(52) U.S. Cl. CPC H04L 63/1425; H04L 63/1416; H04L 63/1441

(57) ABSTRACT

A method and system for detecting potentially anomalous network traffic based on histograms is discussed herein. The system uses a detection device to monitor incoming network traffic using one or more histograms. The histograms assist with detecting sudden changes in a pattern of network traffic. When potentially anomalous network traffic is observed, the detection device notifies an orchestration device such that further mitigation actions can be taken to limit damage to the network.

### CROSS-REFERENCE TO RELATED APPLICATIONS

N/A

### TECHNICAL FIELD

This disclosure relates generally to data processing and more particularly to detection of anomalous network traffic.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

In computer networking, malicious network traffic can slow down legitimate network traffic, and even cause some network services to be completely unavailable to users. As increasing numbers of devices become accessible over a network, it becomes imperative to protect those devices by expediently identifying and sequestering malicious network traffic, such that legitimate network traffic can continue to pass through the network.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for detecting potentially anomalous network traffic. According to one of the approaches of the present disclosure, a system for detecting anomalous network traffic is provided. Specifically, the system may include a detection device configured to receive network traffic from a client destined for a server, monitor at least one histogram for the network traffic, the at least one histogram plotting a feature of the network traffic, and determine whether the network traffic is potentially anomalous if a feature of the network traffic exceeds a predetermined threshold for the at least one histogram. The system may also include a mitigation device configured to filter the potentially anomalous network traffic; and transmit clean network traffic to the server, wherein the clean network traffic comprises network traffic that is not potentially anomalous.

According to another approach of the present disclosure, a method for detecting anomalous network traffic by a detection device is provided. The method may be implemented by a detection device, and include receiving network traffic from a client destined for a server, monitoring at least one histogram for the network traffic, the at least one histogram plotting a feature of the network traffic, determining whether the network traffic is potentially anomalous if a feature of the network traffic exceeds a predetermined threshold for the at least one histogram, and notifying an orchestrator device of the potentially anomalous network traffic.

In further example embodiments of the present disclosure, hardware systems or devices can be adapted to perform the recited operations. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements.

FIG. 1 shows an environment, within which methods and systems for anomalous traffic detection can be implemented.

FIG. 2 is a block diagram illustrating modules of a system for anomalous traffic detection, according to an example embodiment.

FIG. 3 shows an exemplary histogram that is used for detecting potentially anomalous network traffic.

FIG. 4 shows another exemplary histogram for detecting potentially anomalous network traffic.

FIG. 5 shows a table of different histogram types that may be used to detect potentially anomalous network traffic.

FIG. 6 shows an exemplary environment of a network under attack, within which methods and systems for anomalous traffic detection can be implemented.

FIG. 7 shows an table of exemplary thresholds for each histogram type.

FIG. 8 is a flow diagram illustrating a method for detecting anomalous network packets, according to an example embodiment.

FIG. 9 is a block diagram illustrating a network node, according to an example embodiment.

FIG. 10 shows a diagrammatic representation of a computing device for a machine, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive or computer-readable medium. It should be noted that methods disclosed herein can be implemented by a computer (e.g., a desktop computer, a tablet computer, a laptop computer), a game console, a handheld gaming device, a cellular phone, a smart phone, a smart television system, and so forth.

As discussed herein, the embodiments of the present disclosure are directed to detection of anomalous network traffic.

A system and method for detecting anomalous network traffic via comparison with historical network traffic data organized as bins of one or more histograms are disclosed. In some embodiments, a computing system separates network traffic by different features, parameterizes a period of time behavior for each feature, and stores these parameters into a histogram table. Each feature has one histogram table. When the distribution or proportion of the specific feature changes over time (as can be visually depicted in a histogram), the monitored object is likely experiencing anomalous traffic, possibly from an attack on the network. The histogram table for each monitored feature is continually updated in real time as network traffic is received and processed.

Histogram-based detection of potential network attacks describes the overall distribution state of each feature of network traffic, and operates by detecting a change in the distribution state of each feature over time. This is unlike traditional threshold-based detection methods, which cannot track distributions and changes in distribution over time.

In one example, a monitored object may have multiple types of histogram tables, with each histogram table dedicated to a specific feature. When the monitored object is first monitored, its network traffic features are parameterized and stored into histogram tables. After an initial learning time is elapsed, a network monitor can track these histogram tables for a specified duration of time, and use a distribution of each histogram table to monitor whether anomalous network traffic is observed. That is, when the distribution or proportion of a particular histogram table changes in a sudden manner by at least a predetermined threshold amount, it is likely due to anomalous network traffic, which may be indicative of one or more types of network attacks.

In one example, a website has content that is composed of images and text. When an attacker tries to attack a website, the attacker may attempt to go to a webpage that doesn't exist because they are trying to explore for the admin page. Alternatively, an attacker may intentionally open specific webpages that would make the website's server busy and provide a short response. A network monitor of the present disclosure may see that the content server is returning short and brief messages (such as server busy), instead of returning content. By observing histograms of traffic going through the server, the network monitor can know that the server has suddenly shifted to returning short messages, and it may be receiving anomalous traffic, such as being under attack.

In another example, a network monitor may see that a server is taking a longer time to return content, even though the content itself has not changed. By monitoring a histogram of an amount of time that a content server takes to return content, a network monitor can see that a time bin has suddenly changed. From this, a network monitor can infer that the content server may be under duress or attack. The network monitor can then call for a next level of help, such as a mitigation action, to be applied to traffic passing through the content server.

In further examples of the present disclosure, one or more histograms may be used to identify a victim IP address, IP subnet, or zone of a network that is receiving anomalous network traffic. From this, the system can then monitor the victim IP address, IP subnet, or zone in a more granular manner. When the anomalous traffic pattern ceases, the granular monitoring of the identified victim IP can cease, thus conserving network and computing resources.

In previous systems, when a network orchestrator configured a zone network, it was only able to detect a zone-service level anomaly. Thus, the orchestrator would configure a mitigator of a network attack with a list of top-K IP addresses. However, in the present disclosure, a detector can use the histograms to identify a specific victim IP or subnet within a zone network. Thus, an orchestrator device can configure a mitigator of a network attack with the specific victim IP address information, allowing for more targeted mitigation actions to be taken towards a network attack.

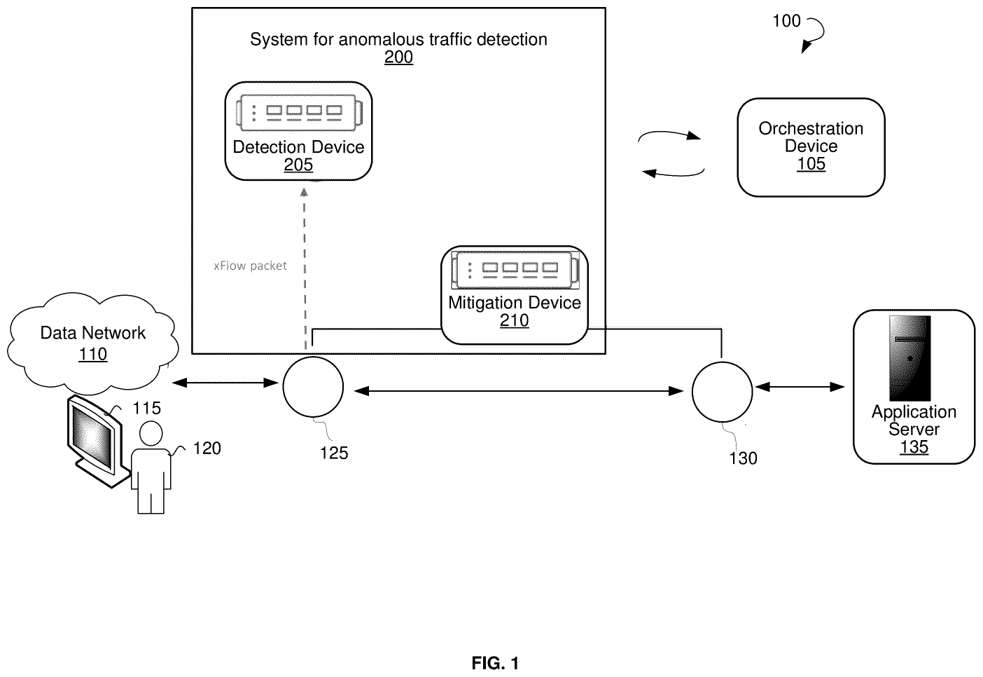

Referring now to the drawings, FIG. 1 illustrates an exemplary environment 100 within which methods and systems for anomalous traffic detection can be implemented. The environment 100 may include a system 200 for anomalous network traffic detection, an orchestration device 105 in communication with system 200, data network 110, client 115, user 120, router 125, internal router 130, and application server 135.

Client 115 may include a computing device associated with a user 120, such as a personal computer (PC), a handheld computer, a smart phone, a tablet PC, a laptop, a server, a wearable device, an Internet-of-things device, or any other computer system. In an example embodiment, the client 115 may include a gaming client enabling the user 120 to play games using the server 135. The server 135 may include one server or a plurality of servers. In an example embodiment, the server 135 may include a gaming server configured to run one or more games and enable the user 120 to play the one or more games using the client 115. In other examples, server 135 may be any type of content server providing content via data network 110. In other examples, server 135 may be any other type of networked component that is to be protected or monitored, including a networked component that is not a “server” per se.

The client 115, router 125, internal router 130, server 135, and the system 200 may be connected to and communicate with each other via the data network 110. Further, orchestration device 105 may be connected to and communicate with system 200 via the data network 110.

The data network 110 may include the Internet, a computing cloud, or any other network capable of communicating data between devices. Suitable networks may include or interface with any one or more of, for instance, a local intranet, a Personal Area Network, a Local Area Network (LAN), a Wide Area Network (WAN), a Metropolitan Area Network, a Bluetooth™ network, a Wi-Fi™ network, a 3^{rd} Generation (3G)/4th Generation (4G)/5th Generation (5G) network, a Long-Term Evolution network, a virtual private network, a storage area network, a frame relay connection, an Advanced Intelligent Network connection, a synchronous optical network connection, a digital Transmission System Level 1 (T1), Transmission System Level 3 (T3), E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an Institute of Electrical and Electronics Engineers (IEEE) 802.11-based radio frequency network.

Data network 110 can further include or interface with any one or more of a Recommended Standard 232 serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking. While not expressly depicted, data network 110 may include a network of data processing nodes, also referred to as network nodes, that are interconnected for the purpose of data communication.

The system 200 may include a detection device 205, a mitigation device 210, and/or other components not expressly depicted in environment 100 for simplicity. Detection device 205 may receive some or all network traffic sent from client 115 over data network 110 to application server 135 via router 125. In one example, user 120 desires to access content from application server 135, such as playing a game running on server 135, or accessing a webpage hosted by server 135.

System 200 acts as a threat protection system for application server 135, and may mirror or divert network packets sent to the server 135. In one example, detection device 205 receives xFlow packets, that are mirrored packets to those sent by client 115 for server 135, and delivered by data network 110 via router 125. Detection device 205 may monitor this network traffic. If detection device 205 determines that potentially anomalous traffic is being sent to router 125, then detection device may forward the potentially anomalous traffic to mitigation device 210 for further action.

Orchestration device 105 operates as a controller in some examples, for system 200. That is orchestration device 105 may direct detection device 205 to monitor certain metrics related to network traffic, monitor traffic from certain IP addresses, subnets, or zones, monitor traffic directed to certain servers 135, or any other parameter necessary for monitoring an efficacy of network traffic destined for server 135. Further, orchestration device 105 may direct mitigation device 210 to perform a mitigation action when a potential anomaly in network traffic is observed, and direct mitigation device 210 to cease the mitigation action when the potential anomaly in the network traffic has ceased.

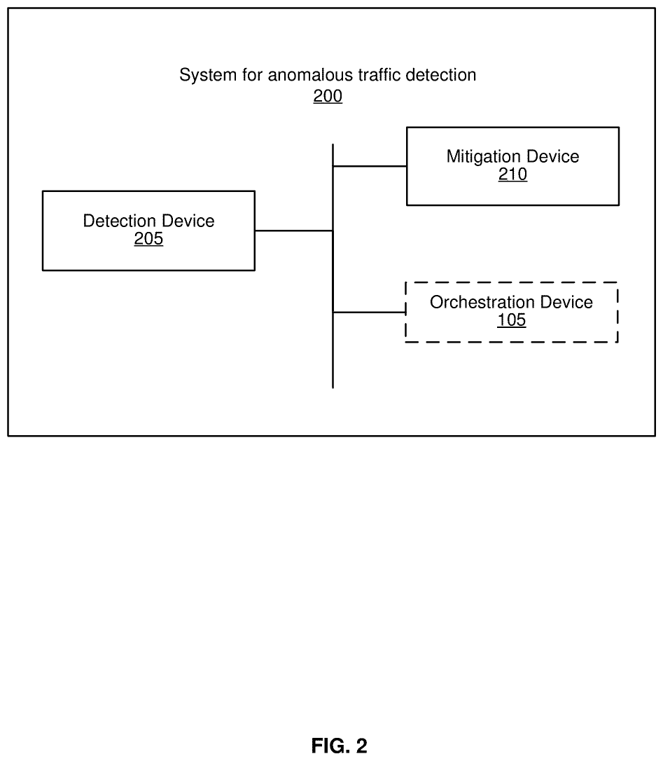

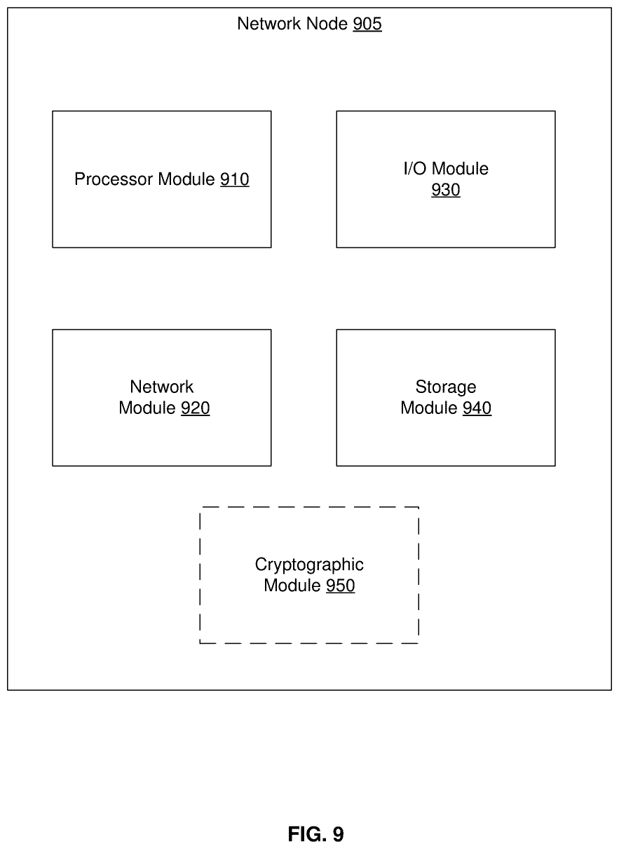

FIG. 2 shows a block diagram illustrating various modules of a system 200 for anomalous network traffic detection, according to an example embodiment. Specifically, the system 200 may include a detection device 205, and a mitigation device 210. Optionally, orchestration device 105 may be considered part of system 200. Each of the detection device 205, mitigation device 210, and the orchestration device 105 may be implemented by a processor or a network node described in detail with reference to FIG. 9. The operations performed by the detection device 205, mitigation device 210, and the orchestration device 105 are described in detail below.

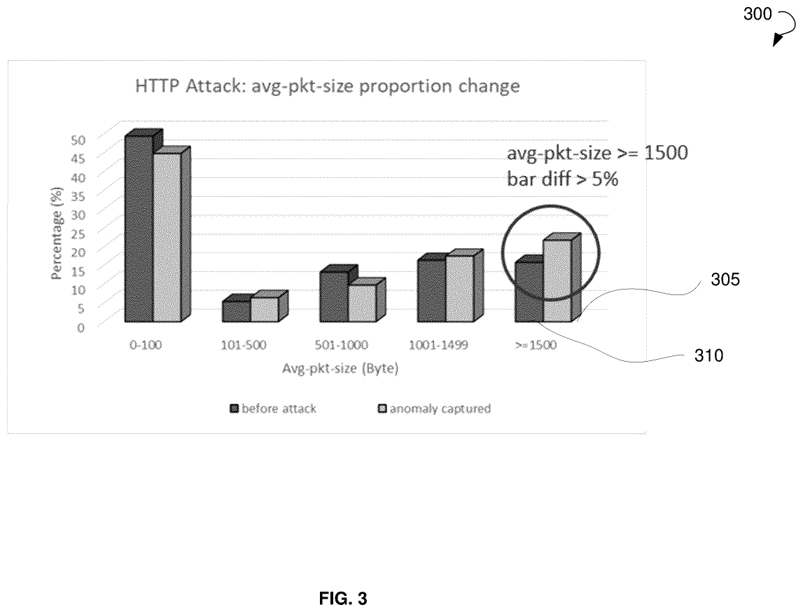

FIG. 3 depicts an exemplary histogram 300 for detecting a potential HTTP attack, which is one type of attack that may be indicated by the anomalous network traffic. The exemplary histogram 300 of FIG. 3 has five bins for categorizing a change in average packet size: 0-100 bytes, 101-500 bytes, 501-1000 bytes, 1001-1499 bytes, and everything greater than 1500 bytes. For each bin, two bars are depicted—the left bar is for traffic received before the HTTP attack, while the right bar is for traffic received after the HTTP attack. While these particular bin breakdowns are used in exemplary histogram 300, other bin breakdowns may be used. That is, there may be fewer or greater bins than five bins in other histograms. Additionally, the bins may be categorized in different ways.

The histogram 300 depicts that packets of all sizes have been received. However, in the bin of packets greater than 1500 bytes in size, an increase of more than 5% in packets of this size was captured. This increase in number of packets of such large size indicates that potentially anomalous traffic is being received. In fact, histogram 300 shows that a bar difference of >5% in average packet size did correlate to an HTTP attack. As such, a similar rule may be applied by system 200 going forward. Namely, that receipt of larger packet sizes by more than 5% may indicate potentially anomalous traffic is being received, and further detection or mitigation may be needed.

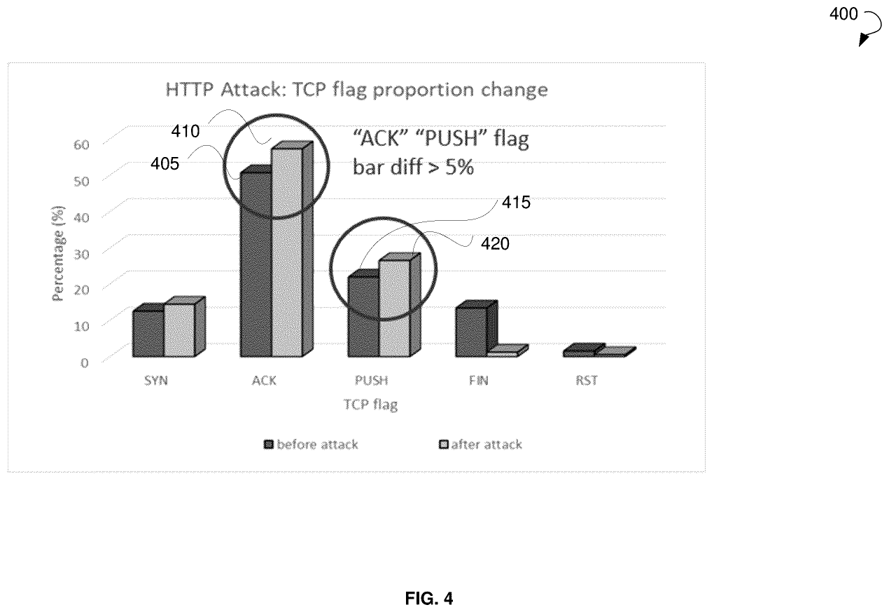

FIG. 4 depicts an exemplary histogram 400 for detecting a potential HTTP attack, which is one type of attack that may be indicated by the anomalous network traffic. The exemplary histogram 400 of FIG. 4 has five bins for categorizing a TCP flag proportion change. The bins are for five types of TCP flags-SYN, ACK, PUSH, FIN, and RST. For each bin, two bars are depicted—the left bar is for traffic received before the HTTP attack, while the right bar is for traffic received after the HTTP attack. While these particular bin breakdowns are used in exemplary histogram 400, other bin breakdowns may be used. That is, there may be fewer or greater bins than five bins in other histograms. Additionally, the bins may be categorized in different ways.

The histogram 400 depicts that TCP flags of all types have been received. However, after an HTTP attack began, there was >5% increase in the number of ACK flags received, as shown by bar 410 being more than 5% greater than bar 405. Further, after the HTTP attack began, there was >5% increase in the number of PUSH flags received, as shown by bar 420 being more than 5% greater than bar 415.

Thus, it can be inferred from histogram 400 that a bar difference of greater than 5% in a number of ACK flags and/or PUSH flags, may correlate to an HTTP attack. As such, a rule may be applied by system 200 going forward, that if detector 105 detects this proportion change of TCP flags, the network traffic being received is potentially anomalous, and further detection or mitigation may be needed.

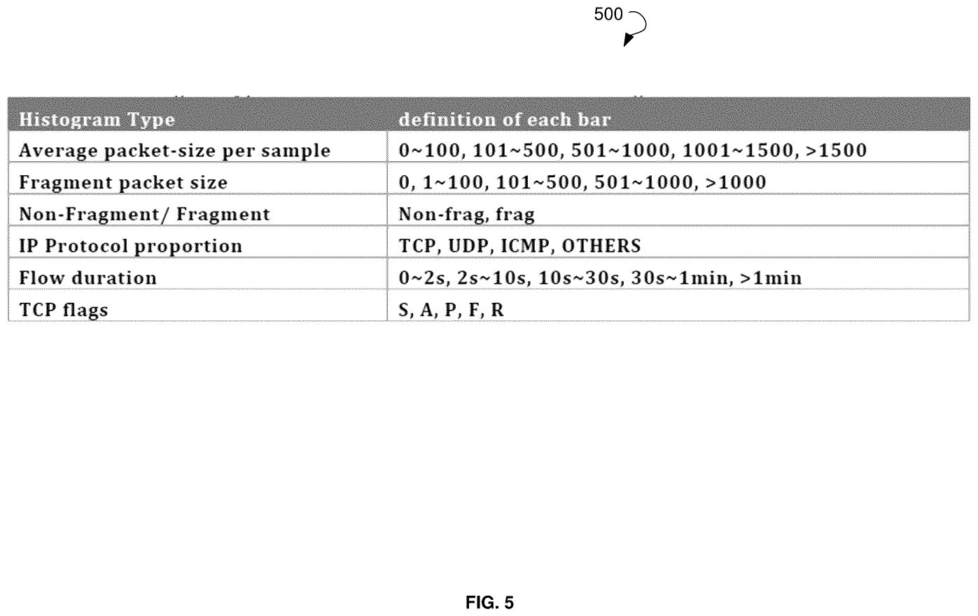

FIG. 5 depicts a table 500 of different histogram types that may be used by system 200 to detect potentially anomalous network traffic, along with the bins that may be used for each histogram type. Table 500 shows six different histogram types that may be used: (1) average packet-size per sample (as depicted in FIG. 3), (2) fragment packet size, as measured in bytes, (3) whether a packet is a fragment or a non-fragment, (4) proportion of packets for specific IP protocols, (5) a flow duration of the network traffic flow, and (6) a type of TCP flag received (as depicted in FIG. 4). While these specific six types of histograms are listed in table 500, there may be additional types of histograms used by system 200 for monitoring network traffic in example embodiments. Further, the definitions for each bin may differ from that shown in table 500.

In an example embodiment, detection device 205 monitors any one or more of the histogram types shown in table 500. Since each histogram monitors a particular feature of network traffic, detection device 205 can simultaneously monitor changes in patterns of network traffic across multiple features, in substantially real time.

In some embodiments, when detection device 205 first begins to monitor a feature of network traffic, it learns from network traffic for a period of time, and stores the parameterized traffic into histogram tables. After this initial learning time, detection device 205 tracks the histogram tables for predetermined time periods. The distribution of each histogram table is used to monitor whether a potential network attack is occurring, as discussed above with respect to FIGS. 3 and 4. When the distribution or proportion of a histogram table changes in a sudden manner over an anomaly threshold (i.e., by a certain percentage), then detection device 205 may determine that potentially anomalous network traffic is being received, and further action is warranted. Otherwise, detection device 205 continues to keep learning and updating the histogram tables by incoming network traffic.

In some embodiments, system 200 may establish a baseline expected histogram for one or more of the histogram types based on monitoring incoming network traffic to server 135 for a period of time. In other embodiments, system 200 may establish a baseline expected histogram for one or more histogram types based on analysis of past data received by server 135. The past data may be from a past network attack.

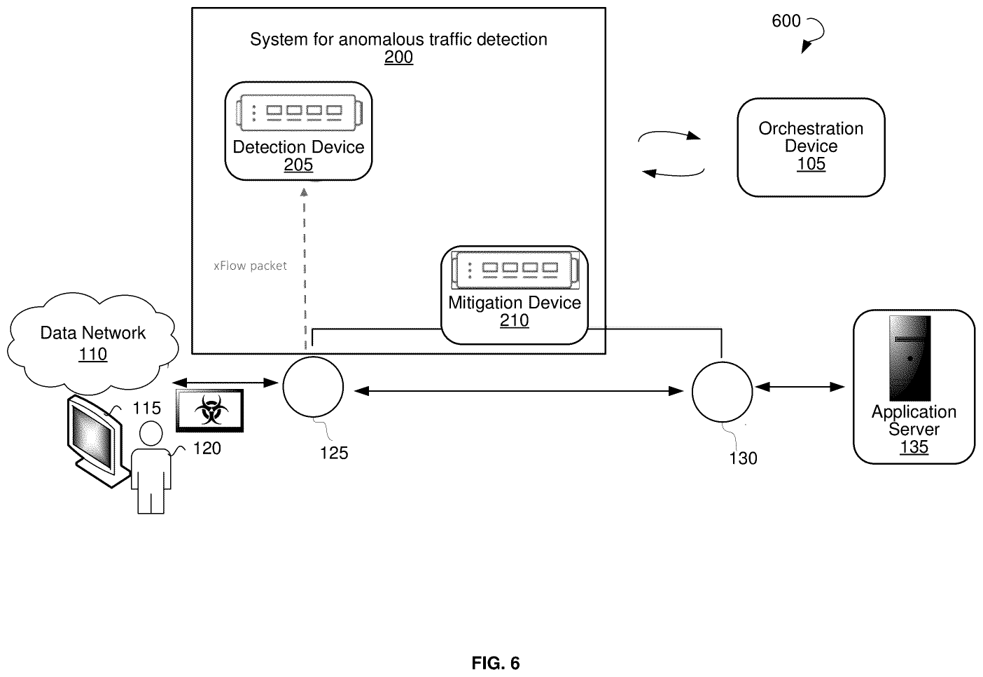

FIG. 6 depicts an exemplary environment 600 for a network that is under attack. In FIG. 6, client 115 initiates a DDOS attack. Detector device 205 uses one or more continuously monitored histograms, as discussed herein, to detect the DDOS attack, and notifies orchestrator device 105 of the victim IP address for the attack. Orchestrator device sets a mitigation rule and communicates to mitigation device 210 to update a routing rule, such that network traffic from client 115 is not forwarded to server 135. Rather, traffic from client 115 is redirected by system 200 to mitigation device 210. Mitigation device 210 only forwards non-attack network traffic (i.e., clean network traffic) to server 135.

When detection device 205 determines that the attack is finished, it sends a notification to orchestrator device 105 that the victim IP anomaly has been cleared. The orchestrator device 105 then sends a message to mitigation device 210 to reset the previous mitigation rule, such that network traffic from client 115 is again forwarded to server 135 without passing through mitigation device 210 for filtering.

In one example, the following algorithm may be used to for identify a victim host:

```
victim-host:
{“IP”: 20.20.101.99,
  “anomaly” : “TRUE”/”FALSE”,
  “type”: “avg-packet-size”/ “frag-size”/ “frag-ratio”/ “proto-proportion”/ “duration”/ “tcp-flag”/ “pkt-rate”/ “b [symbol]
  “reason”: “diff > 5%”/ “any bin > 30%”/ “threshold exceed”,
  “threshold”: None/ num,
} [symbol]
indicates data missing or illegible when filed
```

In the algorithm, the detection device 205 notifies the orchestrator device 105 of a victim host by notifying the orchestrator device 105 that an anomaly condition is TRUE, the type of anomaly that has been detected, and a reason why the anomaly has been detected. In other examples, detection device 205 may notify orchestration device 105 of a potential anomaly using fewer or additional data.

The systems and methods described herein can be applied to monitored network resources, such as a zone of a network, individual IP addresses, or a subnet. That is, detection device 205 may detect that a network zone is experiencing anomalous network traffic, or that an individual IP address is experiencing anomalous network traffic, or a subnet is experiencing anomalous network traffic. The anomalous network traffic is detected based on monitoring histogram thresholds, rather than monitoring individual network packets themselves.

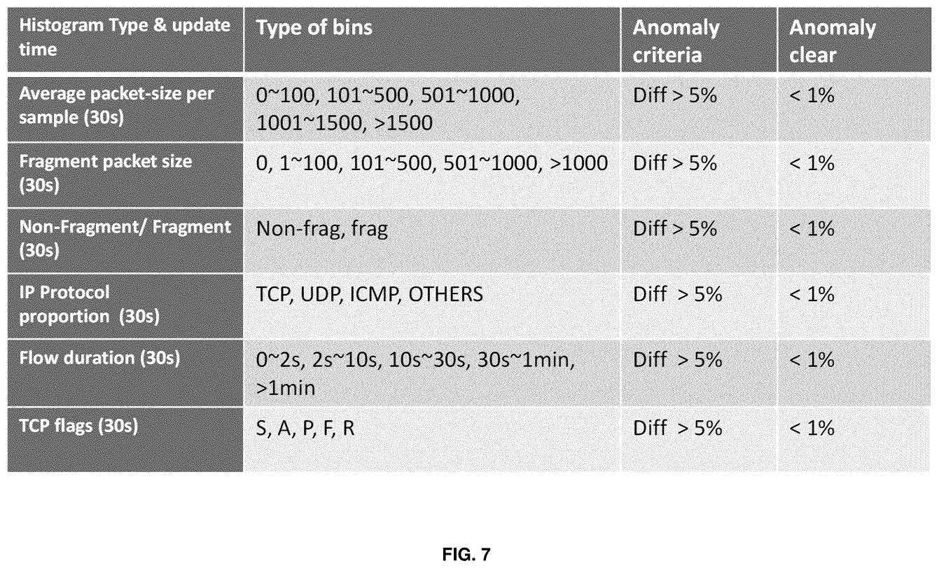

FIG. 7 depicts a table 700 of exemplary thresholds that may be used for each histogram type to determine whether potentially anomalous network traffic is being received, and exemplary thresholds to be used for each histogram type to determine when the potentially anomalous network traffic has been cleared. In table 700, an anomaly difference of >5% is used, while an anomaly difference of <1% is used to determine that an anomaly has cleared. However, these specific thresholds can be customized or configured by a network administrator.

In one example, a detector device 205 first determines that potentially anomalous network traffic is being received in a particular zone of a network, and then applies anomaly logic to determine which specific IP address or IP subnet within the zone is experiencing the anomalous traffic. This victim IP address identification is then sent to orchestrator device 105.

In one example, one or more histograms are monitored for each IP address of a zone for a specified learning time (i.e., 2 minutes) to determine which IP address has histograms meeting the anomaly threshold. The histograms may continue to be updated at specified intervals, such as every 30 seconds, for a period of time. For example, the period of time may be until the anomaly is detected and a victim IP address or subnet is identified, or the period of time may be until the anomaly is cleared, or for any other specified duration. In this way, a victim IP address can be identified within a zone of a network, even if the victim IP address is not in a top-k list of IP addresses for the zone.

In other embodiments, a victim IP address can be identified within a zone of a network using threshold-based criteria instead of, or in addition to, the histograms noted herein. For example, a packet rate (forward & reverse), and/or a byte-rate (forward & reverse) may be monitored for a particular IP address. If the IP traffic is greater than a static configured threshold, then the traffic may be deemed anomalous. If the IP traffic is greater than historical network traffic learned over a specified period (e.g., 2 minutes), then the traffic may be deemed anomalous. If the IP traffic is greater than historical network traffic learned over a specified period within a specific margin (e.g., average plus two standard deviations), then the traffic may be deemed anomalous.

In an example embodiment, detector device 205 may be configured to detect a victim IP address using the following algorithm:

```
ddos dst zone zone
  operational-mode monitor
  continuous-learning
  ip 20.20.28.0/24
  enable-top-k destination num-records 5
  detection settings
    victim-ip-detection configuration
      enable
```

where the exemplary IP address being monitored is 20.20.28.0/24, which is an IP address within the network zone.

In another example embodiment, detector device 205 may be configured to detect an HTTP POST attack (one type of anomalous or attack network traffic) using the following algorithm:

```
ddos dst zone z2
  operational-mode monitor
  continuous-learning
  ip 20.20.28.50
  ip 20.20.28.3
  enable-top-k destination num-records 5
  detection settings
    notification configuration
      notification template n1
      notification template n2
    victim-ip-detection configuration
      enable
      indicator fwd-byte-rate
        threshold 1000000000
      indicator pkt-rate
        threshold 1000000
      indicator rev-byte-rate
        threshold 1000000000
      indicator reverse-pkt-rate
        threshold 1000000
```

In the algorithm, two IP addresses within zone z2 are being monitored for a byte rate and packet rate.

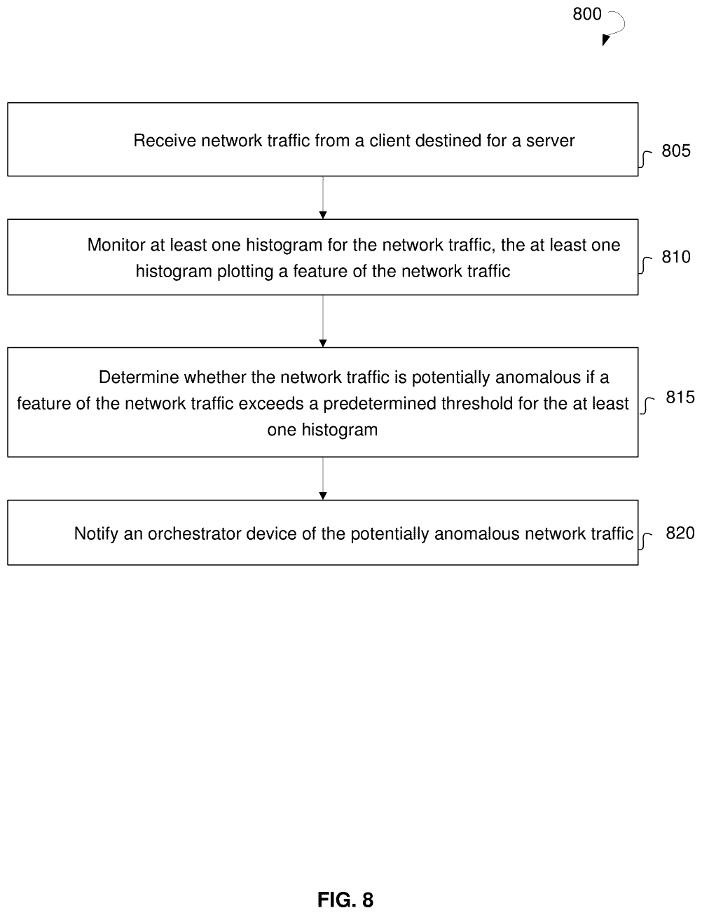

FIG. 8 depicts a process flow diagram of an exemplary method 800 for detecting potentially anomalous network traffic. In some embodiments, operations of the method 800 may be combined, performed in parallel, or performed in a different order. The method 800 may also include additional or fewer operations than those illustrated. The method 800 may be performed by processing logic that may comprise hardware (e.g., decision making logic, dedicated logic, programmable logic, and microcode), software (such as software run on a general-purpose computer system or a dedicated machine), or a combination of both.

In example embodiments, method 800 is implemented by a detection device (such as detection device 105 of environment 100 of FIG. 1) to detect potentially anomalous network traffic. As used herein, anomalous network traffic may comprise attack network traffic, such as an HTTP POST attack, a DDOS (Distributed Denial of Service) attack, or any other type of malicious network traffic.

At step 805 of the exemplary method, detection device receives network traffic from a client destined for a server, At step 810, detection device monitors at least one histogram for the network traffic, the at least one histogram plotting a feature of the network traffic. As used herein, a feature of the network traffic corresponds to a histogram type. There can be any number of histogram types monitored in any combination for network traffic of a monitored zone, subnet, or IP address.

At step 815, detection device determines whether the received network traffic is potentially anomalous (and thus indicative of a potential network attack). This determination is made if a feature of the network traffic exceeds a predetermined threshold for the at least one histogram. In one example, an anomaly is detection if the feature of the network traffic exceeds a predetermined threshold of at least 5%. At step 820, detection device notifies an orchestrator device of the potentially anomalous network traffic. In some examples, the orchestrator can then take a further action to limit or mitigate an impact of the anomalous network traffic on the network.

FIG. 9 is a block diagram illustrating a network node 905, according to an example embodiment. In an example embodiment, any of an detection device 205, a mitigation device 210, orchestration device 105, a client 115, router 125, router 130, and server 135 shown in FIG. 1 may be configured in the form of a network node 905 illustrated in FIG. 9.

In an example embodiment, the network node 905 includes a processor module 910, a network module 920, an input/output (I/O) module 930, a storage module 940, and optionally a cryptographic module 950. The processor module 910 may include one or more processors, such as a microprocessor, an Intel processor, an Advanced Micro Devices processor, a microprocessor without interlocked pipeline stages, an advanced restricted instruction set computer (RISC) machine-based processor, or a RISC processor. In an example embodiment, the processor module 910 may include one or more processor cores embedded in the processor module 910. In a further example embodiment, the processor module 910 may include one or more embedded processors, or embedded processing elements in a Field Programmable Gate Array, an Application Specific Integrated Circuit, or a Digital Signal Processor. In an example embodiment, the network module 920 may include a network interface such as Ethernet, an optical network interface, a wireless network interface, T1/T3 interface, a WAN interface, or a LAN interface. In a further example embodiment, the network module 920 may include a network processor. The storage module 940 may include Random-access memory (RAM), Dynamic Random Access Memory, Static Random Access Memory, Double Data Rate Synchronous Dynamic Random Access Memory, or memory utilized by the processor module 910 or the network module 920. The storage module 940 may store data utilized by the processor module 910. In an example embodiment, the storage module 940 may include a hard disk drive, a solid state drive, an external disk, a Digital Versatile Disc (DVD), a compact disk (CD), or a readable external disk. The storage module 940 may store one or more computer programming instructions which when executed by the processor module 910 or the network module 920 may implement one or more of the functionality of the methods and systems for measuring application response delay described herein. In an example embodiment, the I/O module 930 may include a keyboard, a keypad, a mouse, a gesture-based input sensor, a microphone, a physical or sensory input peripheral, a display, a speaker, or a physical or sensual output peripheral.

The cryptographic module 950 may include one or more hardware-based cryptographic computing modules to perform operations described herein.

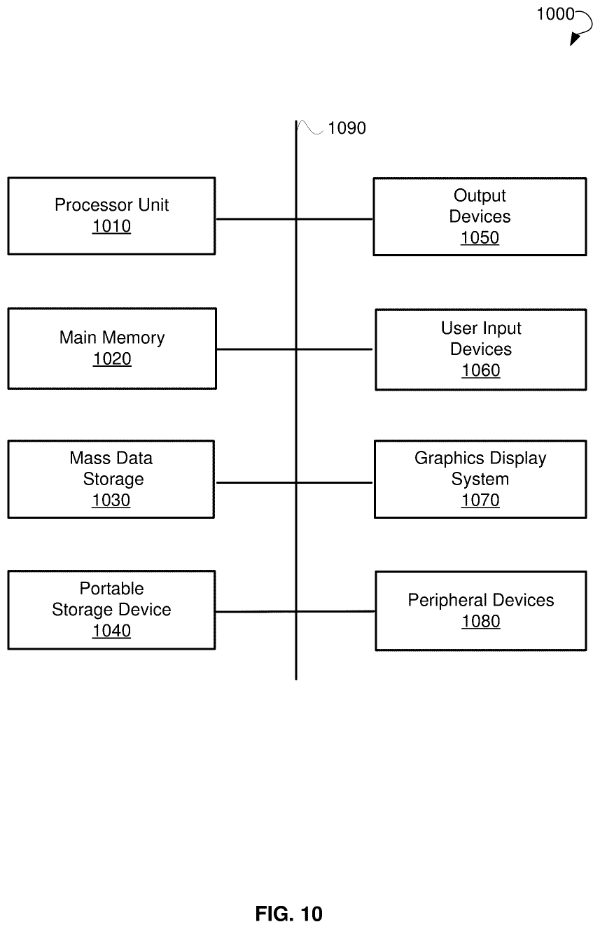

FIG. 10 illustrates a computer system 1000 that may be used to implement embodiments of the present disclosure, according to an example embodiment. The computer system 1000 may serve as a computing device for a machine, within which a set of instructions for causing the machine to perform any one or more of the methodologies discussed herein can be executed. The computer system 1000 can be implemented in the contexts of the likes of computing systems, networks, servers, or combinations thereof. Computer system 1000 includes one or more processor units 1010 and main memory 1020. Main memory 1020 stores, in part, instructions and data for execution by processor units 1010. Main memory 1020 stores the executable code when in operation. The computer system 1000 further includes a mass data storage 1030, a portable storage device 1040, output devices 1050, user input devices 1060, a graphics display system 1070, and peripheral devices 1080. The methods may be implemented in software that is cloud-based.

The components shown in FIG. 10 are depicted as being connected via a single bus 1090. The components may be connected through one or more data transport means. Processor units 1010 and main memory 1020 are connected via a local microprocessor bus, and mass data storage 1030, peripheral devices 1080, the portable storage device 1040, and graphics display system 1070 are connected via one or more I/O buses.

Mass data storage 1030, which can be implemented with a magnetic disk drive, solid state drive, or an optical disk drive, is a non-volatile storage device for storing data and instructions for use by processor units 1010. Mass data storage 1030 stores the system software for implementing embodiments of the present disclosure for purposes of loading that software into main memory 1020.

The portable storage device 1040 operates in conjunction with a portable non-volatile storage medium, such as a floppy disk, a CD, a DVD, or a USB storage device, to input and output data and code to and from the computer system 1000. The system software for implementing embodiments of the present disclosure is stored on such a portable medium and input to the computer system 1000 via the portable storage device 1040.

User input devices 1060 provide a portion of a user interface. User input devices 1060 include one or more microphones, an alphanumeric keypad, such as a keyboard, for inputting alphanumeric and other information, or a pointing device, such as a mouse, a trackball, stylus, or cursor direction keys. User input devices 1060 can also include a touchscreen. Additionally, computer system 1000 includes output devices 1050. Suitable output devices include speakers, printers, network interfaces, and monitors.

Graphics display system 1070 includes a liquid crystal display or other suitable display device. Graphics display system 1070 receives textual and graphical information and processes the information for output to the display device. Peripheral devices 1080 may include any type of computer support device to add additional functionality to the computer system.

The components provided in the computer system 1000 of FIG. 10 are those typically found in computer systems that may be suitable for use with embodiments of the present disclosure and are intended to represent a broad category of such computer components that are well known in the art. Thus, the computer system 1000 can be a PC, handheld computing system, telephone, mobile computing system, workstation, tablet, phablet, mobile phone, server, minicomputer, mainframe computer, or any other computing system. The computer may also include different bus configurations, networked platforms, multi-processor platforms, and the like. Various operating systems may be used including UNIX, LINUX, WINDOWS, MAC OS, PALM OS, ANDROID, IOS, QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit, a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD Read Only Memory disk, DVD, Blu-ray disc, any other optical storage medium, RAM, Programmable Read-Only Memory, Erasable Programmable Read-Only Memory, Electronically Erasable Programmable Read-Only Memory, flash memory, and/or any other memory chip, module, or cartridge.

In some embodiments, the computer system 1000 may be implemented as a cloud-based computing environment, such as a virtual machine operating within a computing cloud. In other embodiments, the computer system 1000 may itself include a cloud-based computing environment, where the functionalities of the computer system 1000 are executed in a distributed fashion. Thus, the computer system 1000, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 1000, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus, methods and systems for mitigating a threat associated with network data packets have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for detecting anomalous network traffic, the system comprising:
a detection device configured to:
receive network traffic from a client destined for a server;
monitor at least one histogram for the network traffic, the at least one histogram plotting a feature of the network traffic; and
determine whether the network traffic is potentially anomalous if a feature of the network traffic exceeds a predetermined threshold for the at least one histogram.

2. The system of claim 1, wherein the system further includes a mitigation device configured to:
filter the potentially anomalous network traffic; and
transmit clean network traffic to the server, wherein the clean network traffic comprises network traffic that is not potentially anomalous; and when an anomalous packet is detected, the mitigation device takes actions to mitigate the attack, to launch a counter attack, to publish the identity of the originator of the anomalous packet, or to take no action.

3. The system of claim 1, wherein the at least one histogram is one or more of the following: an average packet size per sample, a fragment packet size, a fragment/non-fragment packet type, an IP protocol proportion, a flow duration, and a TCP flag type.

4. The system of claim 1, further comprising an orchestrator device configured to receive a notification from the detection device that the feature of the network traffic exceeds the predetermined threshold for the at least one histogram, and instruct the mitigation device to filter the potentially anomalous network traffic.

5. The system of claim 3, wherein the instructing the mitigation device to filter the potentially anomalous network traffic further comprises instructing the mitigation device to update a routing for the network traffic away from the destined server.

6. The system of claim 1, further comprising an orchestrator device configured to receive a notification from the detection device that the feature of the network traffic no longer exceeds the predetermined threshold for the at least one histogram, and instruct the mitigation device to cease filtering the potentially anomalous network traffic.

7. The system of claim 1, further comprising an orchestrator device configured to receive a notification from the detection device that the feature of the network traffic meets an anomaly clear predetermined threshold for the at least one histogram, and instruct the mitigation device to cease filtering the potentially anomalous network traffic.

8. The system of claim 1, wherein the detection device is further configured to identify a victim IP address of the potentially anomalous network traffic, based at least in part on the at least one histogram.

9. The system of claim 1, wherein the detection device is further configured to identify a victim IP subnet of the potentially anomalous network traffic, based at least in part on the at least one histogram.

10. The system of claim 1, wherein the detection device is further configured to generate a baseline of the at the least one histogram from learned network traffic history over a period of time.

11. A method for detecting anomalous network traffic by a detection device, the method comprising:
receiving network traffic from a client destined for a server;
monitoring at least one histogram for the network traffic, the at least one histogram plotting a feature of the network traffic.

12. The method of claim 11, wherein the method further includes:
filtering the potentially anomalous network traffic; and
transmitting clean network traffic to the server, wherein the clean network traffic comprises network traffic that is not potentially anomalous; and if the method determines the network traffic is potentially anomalous if a feature of the network traffic exceeds a predetermined threshold for the at least one histogram, the method notifies an orchestrator device of the potentially anomalous network traffic, the method takes actions to mitigate the potentially anomalous network traffic, to publish the identity of the originator of the anomalous network traffic, or the method takes no action.

13. The method of claim 11, wherein the at least one histogram is one or more of the following: an average packet size per sample, a fragment packet size, a fragment/non-fragment packet type, an IP protocol proportion, a flow duration, and a TCP flag type.

14. The method of claim 11, further comprising notifying an orchestrator device that the potentially anomalous network traffic has cleared.

15. The method of claim 11, further comprising determining a victim IP address of the potentially anomalous network traffic.

16. The method of claim 11, further comprising determining a victim IP subnet of the potentially anomalous network traffic.

17. The method of claim 11, further comprising generating a baseline of the at least one histogram from learned network traffic history over a period of time.

18. The method of claim 11, further comprising generating a baseline of the at least one histogram from learned network traffic history for a known network attack.

19. A system for detecting anomalous network traffic, the system comprising:
a detection device configured to:
receive network traffic from a client destined for a server;
monitor at least one histogram for the network traffic, the at least one histogram plotting a feature of the network traffic;
determine the network traffic is potentially anomalous if a feature of the network traffic exceeds a predetermined threshold for the at least one histogram; and
notify an orchestrator device of the potentially anomalous network traffic; and
a mitigation device configured to:
receive an instruction from the orchestrator device to redirect the potentially anomalous network traffic away from the destined server; and
update a routing of the potentially anomalous network traffic away from the destined server.

20. The system of claim 19, wherein the mitigation device is further configured to receive an instruction from the orchestrator device to reset the routing of the potentially anomalous network traffic back to the destined server.
